(19) United States
(12) Patent Application Publication
(10) Pub. No.: US 2004/0091200 A1
(43) Pub. Date: May 13, 2004

(54) Optical switch device

(75) Inventor: Tetsuo Ikegame, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/293,240

(22) Filed: Nov. 13, 2002

(51) Int. Cl. G02B 6/35

(52) U.S. Cl. 385/18; 385/17

(57) ABSTRACT

Four galvano mirrors 2(1) to 2(4) are constituted in an array in a galvo unit 1. Four galvano mirrors 32A(1) to 32A(4), and 32B(1) to 32B(4) are constituted in an array in galvo units 30A and 30B, respectively. When constituting an optical switch device for switching the optical signal of an input 2 and an output 2, and four galvano mirrors are provided, respectively while two galvano mirrors are sufficient for each galvo unit because two optical paths are provided. Therefore, the number of the galvano mirrors constituted in one galvo unit is doubly affordable. The yield of the optical switch device in which a plurality of galvano mirrors are simultaneously manufactured in an array is improved, the service life of the optical switch after the operation is prolonged, or the repair cost in a failure can be reduced.

This application claims benefit of Japanese Application No. 2001-267771 filed in Japan on Sep. 4, 2001, the contents of which are incorporated by this reference.

### BACKGROUND OF THE INVENTION

1. Field of the Invention

The present invention relates to an optical switch device for switching an optical path used for optical communication, and more specifically, it relates to an optical switch device in which a main box comprising a plurality of optical element drive units is assembled with an input-output box on the input-output side.

2. Description of the Related Art

As for an optical switch array used for optical communication, etc., a device shown in FIG. 13 is disclosed in, for example, Japanese Unexamined Patent Application Publication No. 9-159937.

FIG. 13 is an assembly and disassembly perspective view showing main components of the optical modulating device. In this figure, the optical modulating device roughly comprises a silicon-made mirror substrate 100, a glass-made electrode substrate 200, and a cover glass-made substrate 300.

The silicon-made mirror substrate 100 has a plurality of micro-mirrors 102 arrayed on a matrix. The micro-mirrors 102 arrayed along one direction, for example, the X-direction in FIG. 13 out of the plurality of micro-mirror 102 are connected to each other via torsion bars 104. In addition, a frame part 106 is provided around an area with the plurality of micro-mirrors 102 arranged therein. The frame part 106 is connected to both ends of the plurality of torsion bars 104.

A slit 108 is formed around connection parts of the micro-mirrors 102 and the torsion bars 104. By forming the slit, the micro-mirrors 102 are easily inclined in the (rotational) direction around the X-direction. In addition, a reflecting layer 102a is formed on the surface of the micro-mirrors 102. The reflecting direction of the light incident on the micro-mirrors 102 is changed by the drive described below to incline the micro-mirrors 102. The light is modulated by controlling the time for reflecting the light toward a predetermined reflecting direction.

The plurality of micro-mirrors 102 are connected to each other via the torsion bars 104, and simultaneously manufactured on one silicon-made mirror substrate 100.

Each electrode corresponding to the plurality of micro-mirrors 102 is formed on one glass-made electrode substrate 200. In the glass-made electrode substrate 200, symbol 202 denotes a recessed part, 204 denotes a riser part, 206 denotes an electrode outlet, 208 denotes an electrode take-out plate part, 212 denotes a wiring pattern part, 214 denotes a first address electrode, 216 denotes a second address electrode, 218 denotes a first common wire, and 220 denotes a second common wire.

A cover glass-made substrate 300 is joined with a silicon-made mirror substrate 100. As described above, the optical modulating element having the plurality of movable micro-mirrors 102 in an array is simultaneously obtained by a semiconductor process.

When the micro-mirrors 102 is driven for ON-inclination, the plurality of micro-mirrors 102 arrayed along the X-direction shown in FIG. 13 are simultaneously energized via the torsion bars 104. At the same time, one set of first and second address electrodes 214 and 216 are point-successively or line-successively driven, the energized torsion bars 104 are successively selected toward the Y-direction in FIG. 13 to drive the micro-mirrors 102 arrayed in a matrix for ON-inclination in a predetermined cycle.

On the other hand, in order to drive the micro-mirrors 102 for OFF-inclination, the polarity of the voltage applied to the first and second address electrodes 214 and 216 is set to be opposite to that during the drive for ON-inclination. The micro-mirrors 102 are driven for inclination in the direction opposite to that during the drive for ON-inclination.

A configuration of the optical modulating element for integrally and simultaneously obtaining a plurality of movable mirrors as disclosed in Japanese Unexamined Patent Application Publication No. 9-159937 has more advantages in that space losses are less, and the assembly man-hour is less than a configuration in which one movable mirror is manufactured, and a plurality of the movable mirrors are assembled on a base plate.

However, in the configuration of the optical modulating element in which a plurality of movable mirrors are integrally and simultaneously obtained, all the movable mirrors must be non-defective. Therefore, for example, when 4×4, total 16 movable mirrors are included in the optical modulating element, the non-defective ratio is dropped to 85% (=0.99¹⁶) even if the non-defective ratio of one movable mirror is assumed to be 99%. If the non-defective ratio of one movable mirror is assumed to be 90%, the non-defective ratio of the optical modulating element is dropped to 19% (=0.9¹⁶). In addition, if the number of the movable mirrors is increased to 100, 1,000, etc., the non-defective ratio of the optical modulating element is considerably dropped, the cost is increased, and the mass productivity becomes decreased.

Further, if one micro-mirror is failed after operating the optical modulating element, the optical modulating element having a plurality of micro-mirrors must be exchanged. Thus, the repair cost is considerably increased.

### SUMMARY OF THE INVENTION

An object of the present invention is to provide an optical switch device capable of improving the yield of an optical switch in which a plurality of optical path selection elements are simultaneously manufactured in an array.

Another object of the present invention is to provide an optical switch device capable of prolonging the service life of an optical switch after operating the optical switch in which a plurality of optical path selection elements are simultaneously manufactured in an array, or capable of suppressing the repair cost to be low in a failure.

The optical switch device of the present invention comprises at least one spare optical path selection element to the number of the plurality of optical path selection elements to be exchanged in the optical switch device having the plurality of optical path selection elements for selectively switching a plurality of second optical paths to one or a plurality of first optical paths.

The optical path selection element has an optical element, and the plurality of optical path selection elements are connected to each other as the optical element drive unit, and manufactured. A mirror, for example, is used for the optical element.

### BRIEF DESCRIPTION OF THE DRAWINGS

FIG. 1 is a block diagram showing the configuration of an optical switch device for optical communication according to a first embodiment.

FIG. 2 is an illustration describing the operation of the optical switch device in FIG. 1.

FIG. 3 is an assembly perspective view describing a second galvo unit in FIG. 1.

FIG. 4 is a sectional view of the second galvo unit in FIG. 1 when viewed in the direction orthogonal to the axis of rotation.

FIG. 5 is a perspective view describing the configuration on a back side of a mirror in the second galvo unit in FIG. 1.

FIG. 6 is an assembly perspective view describing a first galvo unit in FIG. 1.

FIG. 7 is a sectional view of the first galvo unit in FIG. 1 when viewed in the direction orthogonal to the axis of rotation.

FIG. 8 is an assembly perspective view describing another configuration of the first galvo unit in FIG. 1.

FIG. 9 is a sectional view of another configuration of the first galvo unit in FIG. 1 when viewed in the direction orthogonal to the axis of rotation.

FIG. 10 is an illustration of a configuration of a galvo array applicable to the optical switch device in FIG. 1.

FIG. 11 is an illustration of another configuration of a galvo array applicable to the optical switch device in FIG. 1.

FIG. 12 is an illustration of the operation of the optical switch device for optical communication according to a second embodiment.

FIG. 13 is a block diagram showing the configuration of a conventional optical modulating device.

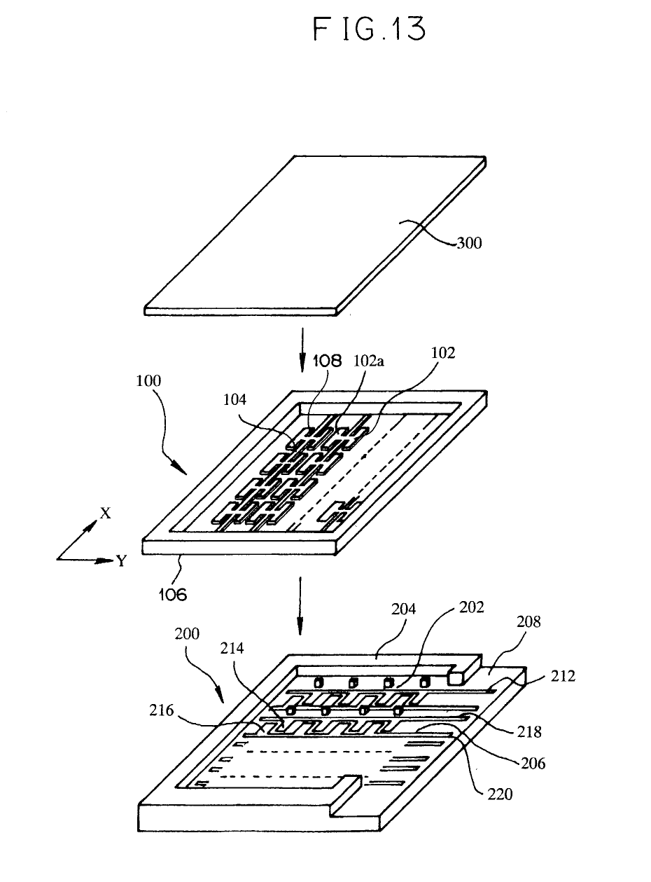

### DETAILED DESCRIPTION OF THE PREFERRED EMBODIMENTS

The embodiments of the present invention will be described below with reference to the drawings.

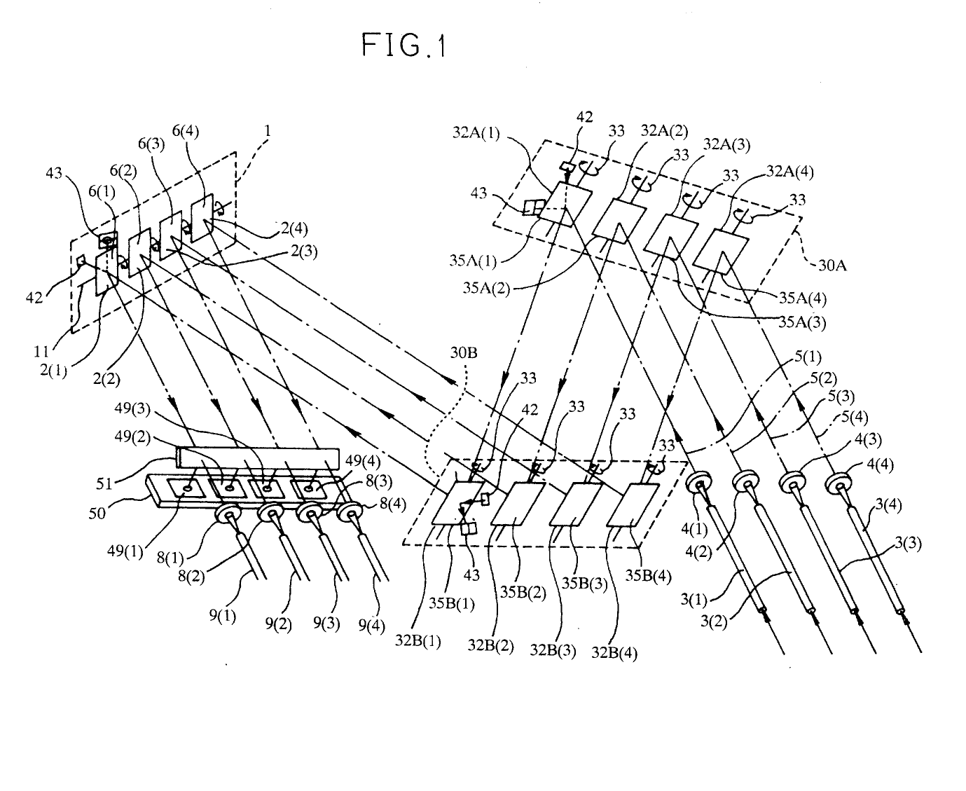

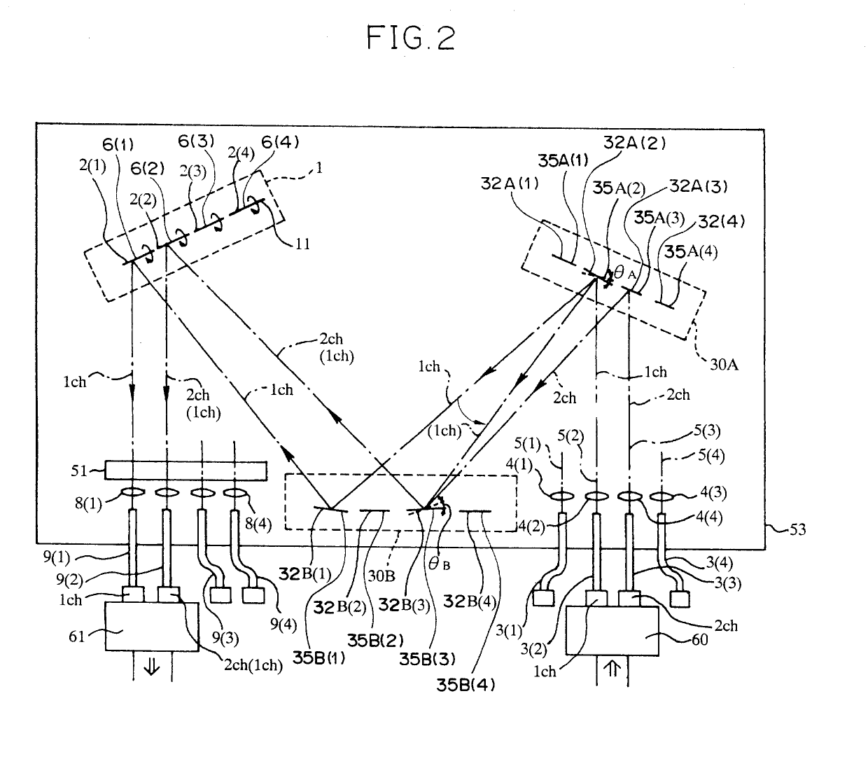

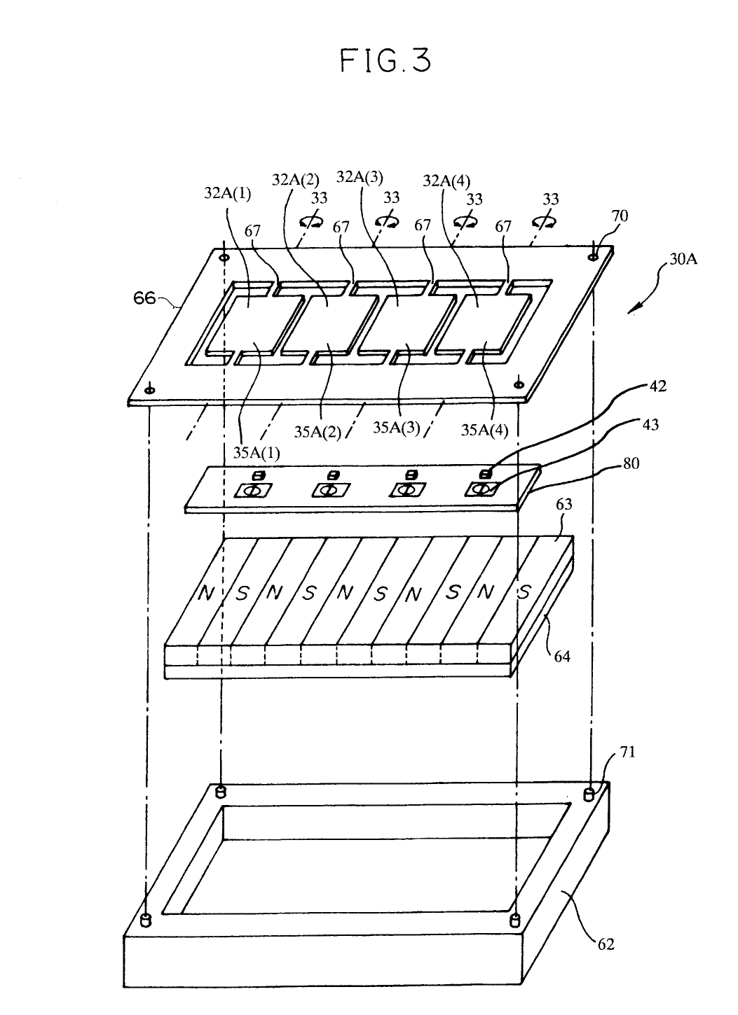

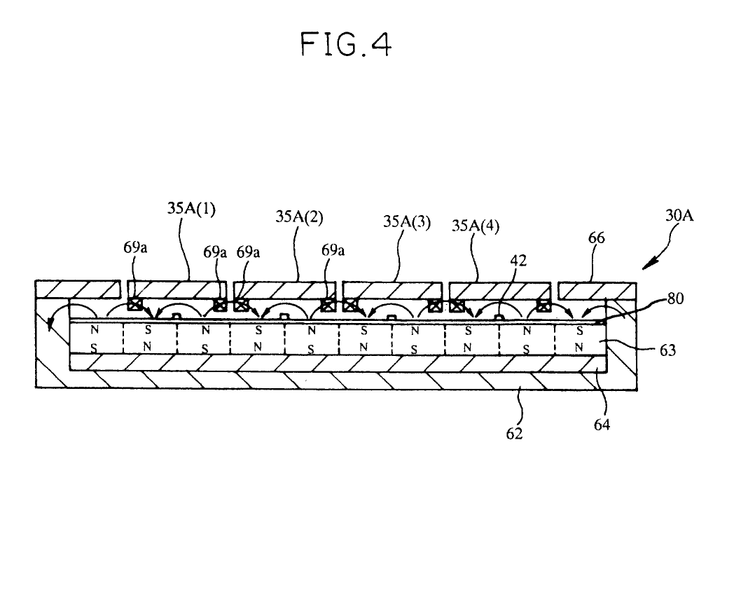

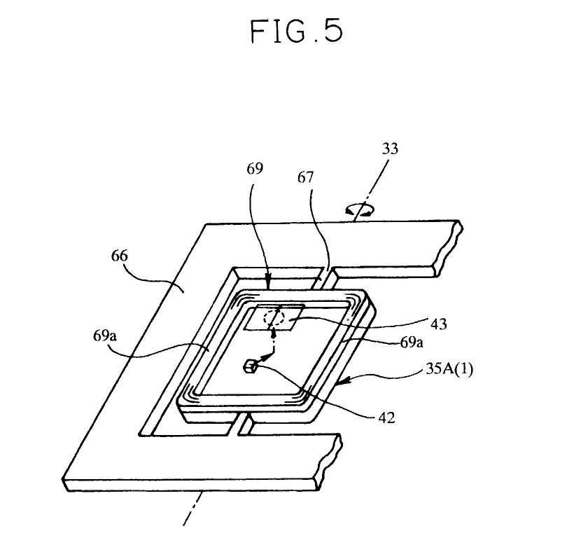

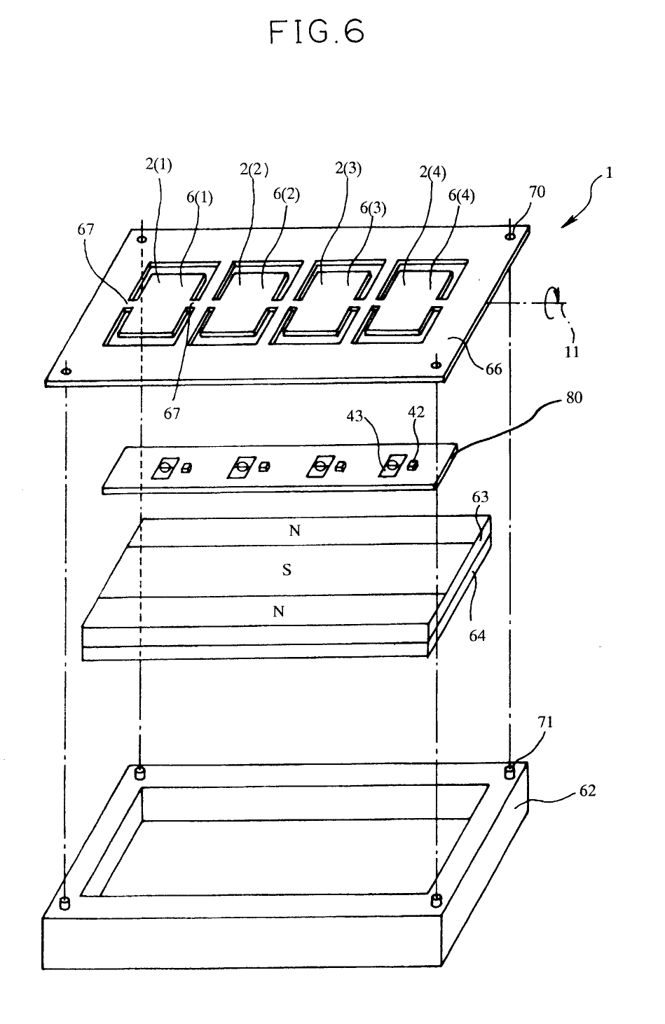

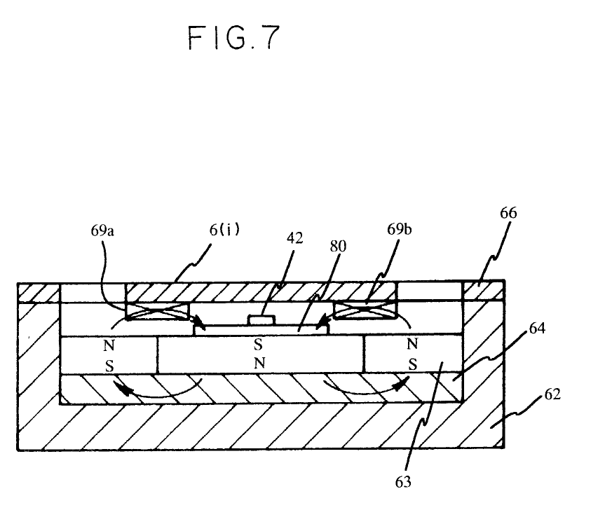

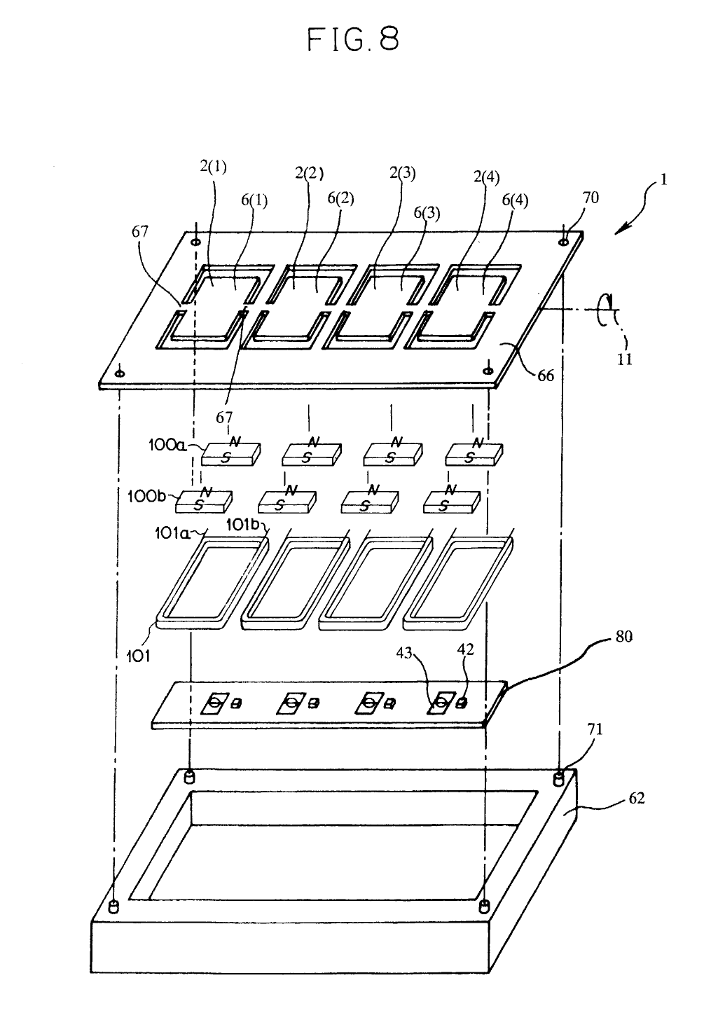

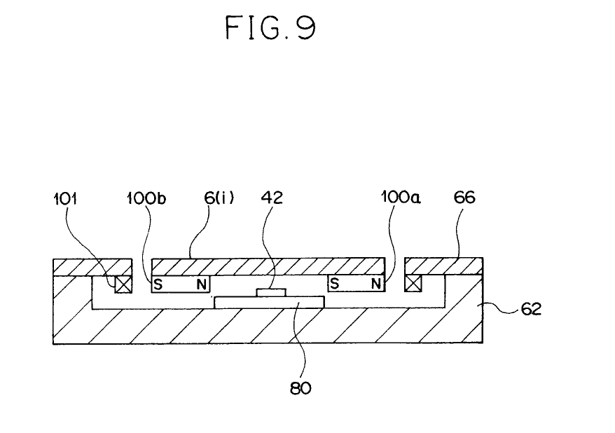

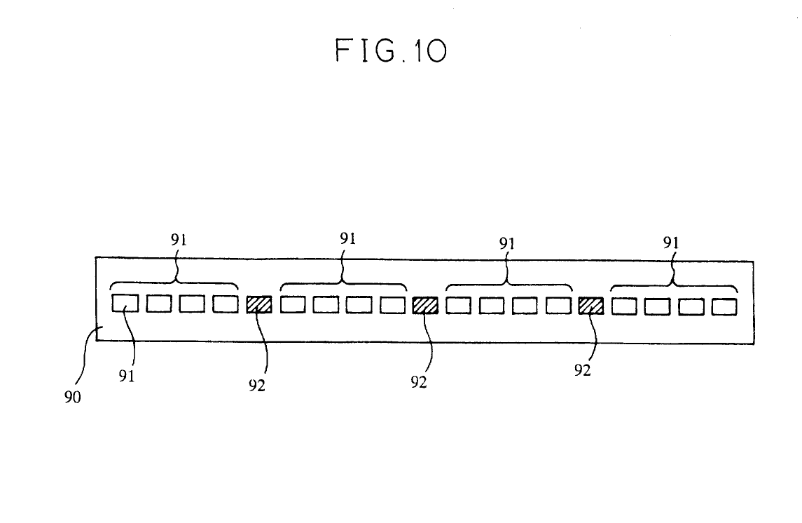

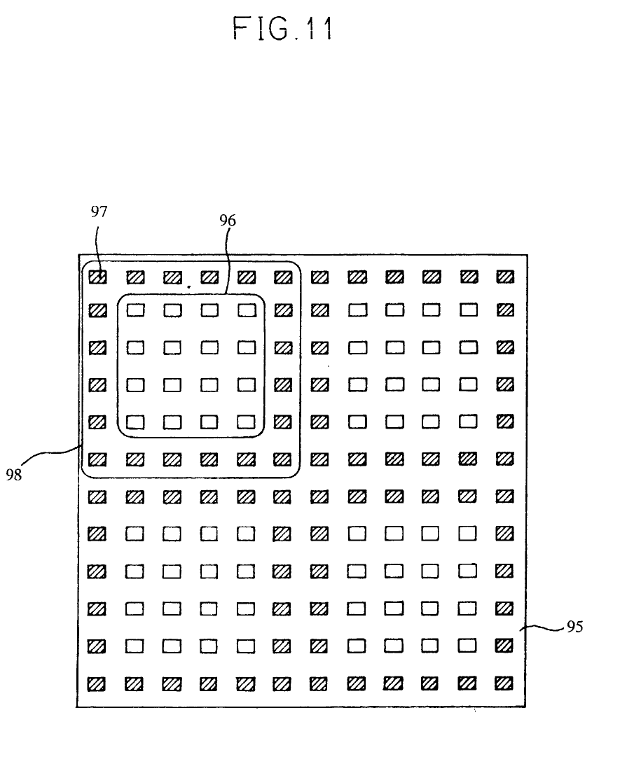

FIGS. 1 to 9 relate to a first embodiment of the present invention, FIG. 1 is a block diagram showing the configuration of an optical switch device for optical communication, FIG. 2 is an illustration describing the operation of the optical switch device in FIG. 1, FIG. 3 is an assembly perspective view describing a second galvo unit in FIG. 1, FIG. 4 is a sectional view of the second galvo unit in FIG. 1 when viewed in the direction orthogonal to the axis of rotation, FIG. 5 is a perspective view describing the configuration on a back side of a mirror in the second galvo unit in FIG. 1, FIG. 6 is an assembly perspective view describing a first galvo unit in FIG. 1, FIG. 7 is a sectional view of the first galvo unit in FIG. 1 when viewed in the direction orthogonal to the axis of rotation, FIG. 8 is an assembly perspective view describing another configuration of the first galvo unit in FIG. 1, FIG. 9 is a sectional view of another configuration of the first galvo unit in FIG. 1 when viewed in the direction orthogonal to the axis of rotation, FIG. 10 is an illustration of a configuration of a galvo array applicable to the optical switch device in FIG. 1, and FIG. 11 is an illustration of another configuration of a galvo array applicable to the optical switch device in FIG. 1.

An “optical element drive unit” is a configuration in which a plurality of mirrors are disposed in an array when, for example, mirrors are used for optical elements, and is a unit used to deflect the light of a plurality of channels input by driving the plurality of mirrors by the electromagnetic force and the electrostatic force (hereinafter, referred to as the “galvo unit”). FIG. 1 illustrates a configuration of the optical switch device for optical communication using, for example, one first galvo unit 1 and two second galvo units 30A and 30B for the optical element drive unit.

As illustrated in FIG. 1, each of the galvo unit 1, 30A and 30B comprises a plurality of (four in the figure) galvano mirrors.

The optical switch device of the configuration in FIG. 1 according to the actually used embodiment is a 2×2 optical switch having 2-channel input and 2-channel output as shown in FIG. 2, and selectively switches a plurality of second optical paths on the output side to at least one first optical path on the input side by leading two signal lights from two optical fibers in four optical fibers 3(1) to 3(4) for input by using two optical fibers out of four optical fibers 9(1) to 9(4) for output.

In the present embodiment, an exiting optical path from the optical fibers 3(1) to 3(4) for input and an incoming optical path to the optical fibers 9(1) to 9(4) for output are disposed parallel to the arrangement direction (the longitudinal direction) of the optical fibers for input.

Four galvano mirrors 2(1) to 2(4) are constituted in an array in the galvo unit 1. Four galvano mirrors 32A(1) to 32A(4) are constituted in an array in the galvo unit 30A, and four galvano mirrors 32B(1) to 32B(4) are constituted in an array in the galvo unit 30B. As shown in FIG. 2, there are two optical paths, each galvo unit has four galvano mirrors while two galvano mirrors are sufficient for each galvo unit. Accordingly, the number of the galvano mirrors constituted in one galvo unit is affordable twice. This means that two galvano mirrors in one galvo unit are actually used, and two remaining galvano mirrors are disposed for spares.

FIG. 1 shows a state in which each of four galvano mirrors of each galvo unit is serviceable, and four optical paths are used. Firstly, description is performed on FIG. 1.

The light emitted from each optical fiber 3(i) for input (hereinafter, i is either one of 1 to 4) is turned into the parallel light by a lens 4(i), and the incoming light 5(i) is projected on a mirror 35A(i) of the galvano mirror 32A(i) of the galvo unit 30A having the rotation axis 33 in the perpendicular direction. The reflected light is further projected on the mirror 35B(i) of the galvano mirror 32B(i) of the galvo unit 30B having the rotation axis 33 in another perpendicular direction.

The reflected light is projected on a mirror 6(i) of a galvano mirror 2(i) of the galvo unit 1 having the rotation axis 11 in the horizontal direction, the reflected light is allowed to transmit a beam splitter 51 which is a beam splitting means comprising parallel flat plates, and the transmitted light is allowed to be incident on the lens 8(i), and further incident on the optical fiber 9(i) for output. The beam splitter 51 comprises a half mirror which reflects a part of the incoming light and transmits a remainder thereof.

Each angle of inclination of the mirror 35A(i), 35B(i) and 6(i) of the galvo units 30A, 30B and 1 is detected by a sensor comprising an LED (abbreviation of Light Emitting Diode) 42 as a light emitting element of each mirror and a PD (abbreviation of Photo Diode) 43 as a light receiving element with a light receiving surface split into a plurality of pieces (two or four), and the detected output is fed to a drive control means (not shown) to set the angle of inclination of each mirror at a predetermined value.

In addition, a part (about 1-20%) of the light incident on the beam splitter 51 is reflected, and received by a PD 49(i) disposed therebelow. The beam splitter 51 is coated so that the reflectance to the PD 49(i) side and the transmissivity to the lens 8(i) side are substantially consistent even when the deflecting direction and the wavelength of the incoming light is changed. The light receiving surface of each PD is split into four pieces, and the positions in two directions of the incoming light on the receiving surface are detected by operating the output of each of the four-split PD. It can thus be detected whether or not the light incident on the beam splitter 51 is correctly incident on the optical fiber 9(i) for output through the lens 8(i).

A PD using a silicon substrate is used for the PD 49(i) if the light from the optical fiber 3(i) is the visible light or the near-infrared light (0.4-1.1 μm). If the light from the optical fiber 3 is as long as 1.3 to 1.6 μm, the PD using a gallium-arsenic substrate or a germanium substrate.

In addition, in place of the PD, a PSD (abbreviation of Position Sensitive Detector) which is a semiconductor position detection sensor, for example, S4581 as a one-dimensional PSD or S5990 as a two-dimensional PSD by Hamamatsu Photonics K.K. can be used.

Four PD 49(1) to 49(4) are disposed corresponding to four incoming lights 5(1) to 5(4), and they are disposed on one substrate 50.

The position on the PD 49(i) in a state in which the position of the light incident on each optical fiber 9(i) for output is optimum [the state in which the light spot incident on the optical fiber 9(i) from the lens 8(i) is located substantially at the center of a core of the optical fiber 9(i), and the quantity of light transmitted from the optical fiber 9(i) to the reception side is maximized] is stored in a memory of a drive control means in advance. The drive control means controls each mirror so that the angle detected by the sensor comprising the LED 42 and the PD 43 provided on each galvano mirror forms the angle of inclination corresponding to the channel switching of a plurality of input lights, and controls the angle of inclination of each mirror of the plurality of galvano mirrors so that the light spot is located at the predetermined position on the PD 49(i) stored in advance.

Each light for communication incident through four optical fibers 3(1) to 3(4) for input is selectively incident on any one of the optical fibers 9(1) to 9(4) for output.

The optical fibers 3(1) to 3(4), the lenses 4(1) to 4(4), the galvo unit 30A, the galvo unit 30B, the galvo unit 1, the beam splitter 51, the lenses 8(1) to 8(4), and the optical fibers 9(1) to 9(4) are disposed on one plane, and constituted in a substantially M-shaped manner with three galvo units (1, 30A and 30B) combined with each other as shown in FIG. 2. These components are disposed inside a main box accommodating the optical switch 53.

Thus, the thickness of a box for the optical switch 53 can be reduced. The optical fibers 3(1) to 3(4) for input and the optical fibers 9(1) to 9(4) for output are disposed on the same plane of the main box of the optical switch 53. Thus, even when a main box of the optical switch 53 is installed in the longitudinal or transverse direction, the input-output optical fibers and the input-output box can be easily coupled with each other, and the fiber on the transmission-reception side is extracted from one surface, and the arrangement in the vicinity of the main box can be simplified.

Next, as shown in FIG. 2, the optical switch device for switching the optical signal of the input 2 and the output 2 is constituted. It is assumed here that two galvano mirrors 2(3) and 2(4) out of four galvano mirrors 2(1), 2(2), 2(3) and 2(4) constituted in the galvo unit 1 are defective in the manufacturing stage of the galvo unit 1 and cannot be used, and the remaining two galvano mirrors 2(1) and 2(2) can be used. Similarly, in the galvo unit 30A, it is assumed that one galvano mirror 32A(1) is defective, and the remaining three galvano mirrors can be used, and in the galvo unit 30B, it is assumed that two galvano mirrors 32B(2) and 32B(4) are defective, and the remaining two galvano mirrors can be used.

And, it is assumed that two usable galvano mirrors of three galvo units are used, respectively. In other words, during the manufacture, in order to obtain two usable galvano mirrors for each galvo unit, two galvano mirrors are added as spares for defective ones during the manufacture, and four galvano mirrors in total are manufactured in one unit.

Two transmission side optical fibers (not shown) of the number corresponding to the optical fibers 3(2) and 3(3) of two channels ch on the output side are connected to the input side of the input box 60. In addition, two reception side optical fibers (not shown) of the number corresponding to the optical fibers 9(1) and 9(2) of two channels ch on the input side are connected to the output side of the output box 61.

A connector at the input end of the optical fiber 3(2), and a connector at the input end of the optical fiber 3(3) are inserted in 1 ch and 2 ch of two optical fiber connectors (not shown) of 1 ch and 2 ch of the input box 60, respectively.

A connector at the output end of the optical fiber 9(1), and a connector at the output end of the optical fiber 9(2) are inserted in 1 ch and 2 ch of two optical fiber connectors (not shown) of 1 ch and 2 ch of the output box 61, respectively.

The light from 1 ch of the input box 60 reaches 1 ch of the output box 61 via the optical fiber 3(2), the lens 4(2), the galvano mirror 32A(2), the galvano mirror 32B(1), the galvano mirror 2(1), the beam splitter 51, the lens 8(1) and the optical fiber 9(1) as a standard optical path.

The light from 2 ch of the input box 60 reaches 2 ch of the output box 61 via the optical fiber 3(3), the lens 4(3), the galvano mirror 32A(3), the galvano mirror 32B(3), the galvano mirror 2(2), the beam splitter 51, the lens 8(2), and the optical fiber 9(2) as a standard optical path.

Next, the light switching operation according to the present embodiment will be described mainly with reference to FIG. 2.

In an initial state, so as to allow the light from the optical fibers 3(2) and 3(3) is incident on the optical fibers 9(1) and 9(2), respectively, each angle of the mirror 35A(2) and 35A(3) of two galvano mirrors 32A(2) and 32A(3) of the galvo unit 30A, the mirror 35B(1) and 35B(3) of two galvano mirrors 32B(1) and 32B(3) of the galvo unit 30B, and the mirror 6(1) and 6(2) of two galvano mirrors 2(1) and 2(2) of the galvo unit 1 are held so that the differential output of the angle sensor comprising the LED 42 and the PD 43 of each galvano mirror is substantially zero. Here, the differential output is defined as the differential output between two outputs from the PD 43 with the light receiving surface thereof split into two.

The drive control means performs fine adjustment of each angle of the mirror 35A(2) of the galvo unit 30A, the mirror 35B(1) of the galvo unit 30B, and the mirror 6(1) of the galvo unit 1 so that the position of the light incident on the PD 49(1) from the beam splitter is optimized when the light for communication is emitted from the optical fiber 3(2). Each mirror is drive-controlled so as to hold the output of the angle sensor disposed on each mirror in this optimum state, and the angle of each mirror is held.

Next, description will be made on the operation in which the light 1 ch from the optical fiber 3(2) is switched from the optical fiber 9(1) to the optical fiber 9(2) as shown in FIG. 2.

The angle of inclination of the mirror 35A(2) of the galvo unit 30A is changed to be an angle θA determined based on the angle data given to the drive control means in advance and the output of the angle sensor of the mirror 35A(2). Similarly, the angle of inclination of the mirror 35B(3) of the galvo unit 30B is changed to be an angle θB determined based on the angle data given in advance and the output of the angle sensor of the mirror 35B(3).

As a result, the light reflected by the mirror 35A(2) of the galvo unit 30A is directed from the mirror 35B(1) of the galvo unit 30B to the mirror 35B(3), and the reflected light thereof is directed to the mirror 6(2) of the galvo unit 1.

The angle of each mirror of three galvo units is finely adjusted so that the output from the beam splitter 51 to the PD 49 (4) is optimum, each mirror is drive-controlled so as to maintain the output of the angle sensor disposed on each mirror in this optimum condition, and the angle of each mirror is maintained.

As a result, the light 1 ch output from 1 ch of the input box 60 is switched from the optical fiber 9(1) to 9(2), and output, and output to 2 ch side of the output box 61.

Similarly, the light from 2 ch of the input box 60 can be switched from 2 ch to 1 ch of the output box 61.

As described above, the 2×2 optical switches are constituted by using a plurality of galvo units having a plurality of optical path selection elements constituted by the galvano mirror inside.

Next, the galvo units 30A and 30B will be described with reference to FIGS. 3 to 5. Since the same unit is used in the galvo units 30A and 30B in the present embodiment, description will be made for the galvo unit 30A.

The galvo unit 30A is constituted by disposing four galvano mirrors 32A(1) to 32A(4) in an array in the direction perpendicular to each rotating shaft 33. In the galvo unit 30A, one magnet 63 magnetized to a plurality of poles is accommodated and fixed to a bottomed housing 62 via a common yoke 64.

A sensor unit 80 having four PDs 43 fixed thereto is fixed on the magnet 63 with four LEDs 42 and a light receiving surface divided into two portions respectively as shown in FIG. 3. The sensor unit 80 is formed of polyimide, aluminum, silicon, ceramic, etc. which are non-magnetic. A mirror plate 66 having four mirrors 35A(1) to 35A(4) constituting a movable part is fixed on a housing 62 facing this magnet 63.

Four mirrors 35A(1) to 35A(4) are formed on the mirror plate 66 by etching a thin plate formed of stainless steel, poly-silicon, or single crystal silicon. In this case, each square or rectangular plate-like mirror 35A(i) is etched so as to leave a linear part at the center position in the right-to-left direction of upper and lower sides thereof, and each mirror 35A(i) is elastically, rotatably and deformably connected to the mirror plate 66 and supported by a spring 67 formed at the linear part. This means that each mirror 35A(i) is supported with the axis passing through the spring 67 as the rotating shaft 33.

A coating film formed of, for example, gold or a dielectric multi-layered film is deposited on a surface forming a reflecting surface of each mirror 35A(i) to improve the reflectance. A thin polyimide coating film is deposited on a back side of the reflecting surface except a center part thereof to form an insulating layer, and a coil 69 is formed by the electroforming or the etching as shown in FIG. 5.

As shown in FIG. 3, a positioning hole 70 is opened at each position of four corners, and the mirror plate 66 is positioned and fixed by inserting pins 71 disposed on four corners of an upper side of the housing 62 with each positioning hole 70 as a reference.

One magnet 63 with the surface thereof magnetized to ten poles (in the forming direction of the plurality of mirrors 35A(i)) having the yoke 64 affixed thereto is accommodated and fixed in the housing 62 below the mirror 35A(i).

As shown in FIG. 4, an effective side 69a of the coil 69 is located on the boundary of the magnetic poles of the magnet 63. Thus, the direction of the magnetic field applied to the effective side 69a is a substantially horizontal direction in FIG. 4. Therefore, when the current flows in the coil 69, the currents opposite to each other flows in two effective sides 69a of each coil 69, and the torque for rotating the mirror 35A(i) around the rotating shaft 67 is generated. The magnetic flux from adjacent magnetic poles is commonly applied to the two coils 69 of two adjacent mirrors 35A(i).

Four LEDs 42 and the PD 43 are located inside each coil 69 corresponding to four mirrors 35A(i). The light obliquely emitted from the LED 42 is reflected by the back side of the mirror 35A(i), and incident on the PD 43. When the mirror 35A(i) is inclined around the spring 67, the inclination of the mirror 35A(i) can be detected by taking two of the two-divided differential outputs of the PD 43.

As described above, the four galvano mirrors 32A(1) to 32A(4) are integrally formed on one galvo unit 30A. This is similar to the galvo unit 30B. It is not true that the galvano mirrors are assembled by separately assembling four independent galvano mirrors to integrally assemble four of them.

Next, the galvo unit 1 will be described.

As shown in FIGS. 6 and 7, the galvo unit 1 has a configuration substantially similar to that of the galvo unit 30A, and four galvano mirrors 2(1) to 2(4) having the mirrors 6(1) to 6(4) respectively are tiltable around the axis 11 parallel to the array direction. The magnet 63 is magnetized to three poles in the direction perpendicular to the axis 11, and as shown in FIG. 7, the magnetic flux in the horizontal direction is applied to the effective sides 69a and 69b of the coil 69. The array direction of the LED 42 and the PD 43 in the sensor unit 80 is the array direction (i.e., the direction of the axis 11 of rotation) of four galvano mirrors.

Other configuration is substantially equal to that of the galvo unit 30A, and description thereof will be omitted.

The above-described galvo units 1, 30A and 30B has a moving coil system in which a coil is disposed in a movable part, but the moving magnet system in which a magnet is disposed in a movable part may also acceptable.

FIGS. 8 and 9 show an example of modification of the galvo unit 1 in the moving magnet system. The galvo units 30A and 30B can also be modified similarly.

In these figures, one set of the magnets 100a and 100b magnetized in the direction parallel to a reflecting side of the mirror 6(i) are fixed on a back side thereof. The coil 101 wound in a square frame shape is fixed to the back side of the mirror plate 66 so as to surround the magnets 100a and 100b. The terminals 101a and 101b of the coil 101 are soldered to a soldering pattern formed on the back side of the mirror plate 66, and the power is supplied thereto. The sensor unit 80 is fixed to the housing 62.

In the above configuration, the mirror 6(i) can be inclined by allowing the current to flow in the coil 101 disposed on a fixed part of the mirror plate 66. The coil 101 is wound in a single fashion, and a pattern may be formed through the electroforming or the etching on the back side of the mirror plate 66. In addition, the magnets 100a and 100b can also be magnetized by coating or plating the magnetic body on the back side of the mirror 6(i).

Next, description will be made on the non-defective ratio of the galvo unit during the manufacture.

For example, four galvano mirrors 32A(i) are simultaneously formed on one galvo unit 30A. These galvano mirrors 32A(i) can be defective by defective etching of the spring 67, coating flaws on the surface of the mirrors 35A(i), disconnection of the coil 69, etc., but the galvo unit 30A can be regarded as non-defective if two of the four galvano mirrors are non-defective.

If the galvo unit comprises only two galvano mirrors, the two galvano mirrors must be non-defective. On the other hand, in the galvo unit according to the present embodiment, two spares are added, and the galvo unit integrally comprises four galvano mirrors.

For example, if the yield of one galvano mirror is assumed to be 90%, the simulation result of the non-defective ratio of 1,000 galvo units for each case of (a) without any spares (two array galvano mirrors are provided and two of them are used), (b) with one spare (three array galvano mirrors are provided, and two of them are used), and (c) with two spares (four array galvano mirrors are provided, and two of them are used, that is, a case of the present embodiment) is shown below.

(a) without any spares: 80.4%

(b) with one spare: 98.1%

(c) with two spares: 99.8%

As described above, by doubling the number of the spares such as having two spares, the non-defective ratio of the galvo unit is heightened. If the yield of one galvano mirror is much lower than 90%, the difference between the case without spares and the case with spares is further increased.

In the present embodiment, the optical switch having 2×2 input and output channels is constituted by using two non-defective galvano mirrors, and the difference will be considerable in case of the optical switch having more channels.

For example, when the 16×16 optical switch is constituted by using sixteen galvano mirrors, the simulation result of the non-defective ratio of 1,000 galvo units for each case of (a) without any spares using only sixteen galvano mirrors in one galvo unit, (b) with one spare added, using seventeen galvano mirrors, (c) with two spares, and (d) with three spares is shown below.

(a) without any spares: 19.3%

(b) with one spare: 49.7%

(c) with two spares: 73.7%

(d) with three spares: 88.5%

According to this result, if three spares are added, the non-defective ratio can be increased by 4.6 times compared with a case without any spares. Even when the material cost is increased by (16+3)/16=1.19 times for the increase of the spares, the non-defective ratio is increased by 4.6 times, and the manufacturing cost can be reduced considerably. In larger optical switches such as 256×256 and 1,024×1,024 types, considerable effect can be obtained by adding spares.

The optimum number of spares may be selected paying attention to the largest reduction of the cost according to the number of the galvano mirrors which are simultaneously integrated, assembled and arrayed, the yield of one galvano mirror, the parts cost, etc.

The embodiment described with reference to FIGS. 3 to 7 has the following advantages. The yield of the galvo unit can be improved. Further, the parts number is small, and the assembly property is excellent because one magnet is also used for driving a large number of mirrors. In addition, the assembly is easy because the magnet is disposed parallel to the reflecting surface of the mirror, and the mirror, the magnet, the sensor unit and the housing are constituted in a laminating manner in one direction.

Further, an LED and a PD constituting an angle sensor are disposed in a space from a coil. Thus, the space between the mirror and the magnet can be reduced even when the sensor is disposed between the mirror and the magnet.

Still further, a plurality of mirrors constituting a movable part are easily formed together with each supporting member by performing the etching on the common mirror plate 66, the mirror 35A(i), 35B(i) or 6(i) can be arrayed at a desired pitch, and a galvo unit with a plurality of compact galvano mirrors arrayed thereon can be realized at a low cost.

In addition, in the embodiment in FIGS. 8 and 9, the yield of the galvo unit can be improved by providing spare galvano mirrors, a plurality of mirrors can be formed on the common mirror plate 66, and the galvo unit can be manufactured at a low cost.

The present invention is not limited to the above embodiments, and, for example, the number of galvano mirrors and the number of spares simultaneously formed on the galvo array may be appropriately selected according to the channel number of the optical switch, the yield, etc.

In the above embodiments, the optical fiber, the collimate lens, and the angle sensor are used in each of four optical paths including spare galvano mirrors, but only those corresponding to the non-defective galvano mirrors may be assembled.

The galvano mirror with silicon etched thereon is used for the optical path selection element. However, the mirror plate is formed of a metal spring, and insert-molded in a plastic, and a plurality of glass mirrors may be adhered thereto. Also in this case, a plurality of galvano mirrors are simultaneously molded and assembled in one unit.

In the above embodiment, a plurality of galvano mirrors which are arrayed in one direction and inclined in one direction are used. However, galvano mirrors which are inclined in two directions may be used. In addition, the array of the galvano mirrors and the arrangement of spares are not limited to those of the above embodiment, but a variety of arrays and arrangement are possible.

The drive system employs the coil and the magnet. However, the electrostatic drive, a piezoelectric element, etc. may be acceptable. Further, the supporting member is not limited to a silicon spring, but may be a metal spring, a metal link, etc. Here, the link means a mechanical link structure, including a structure shown in FIG. 6 disclosed in U.S. Pat. No. 5,960,132.

For example, as shown in FIG. 10, when sixteen galvano mirrors are arrayed in one row in the galvo array 90, the position of the galvano mirror 91 for standard use and the position of the spare galvano mirror 92 are determined in advance, and these galvano mirrors are arranged in a diffused manner. The related parts such as the collimate lens and the optical fiber corresponding thereto are arranged in advance in a corresponding manner to the standard galvano mirror 91. When any spare galvano mirrors are used, the collimate lens or the optical fiber is added or position-changed in a corresponding manner thereto.

This preparation is convenient when the yield in manufacturing the galvano mirror is excellent. Since spare galvano mirrors are disposed in a distributed manner, only related parts in the vicinity of any defects may be added and moved, and other parts units can be assembled in advance.

As shown in FIG. 11, 6×6×4=144 pieces of galvano mirrors are arrayed in a two-dimensional manner in the galvo array 95. These galvano mirrors are divided into four areas 98, 6×6 galvano mirrors are arrayed in each area, and 4×4 galvano mirrors 96 inside thereof are used as standard. The periphery of the galvano mirrors 96 is surrounded by 20 spare galvano mirrors 97. Thus, the arrangement of the optical path selection elements may be two-dimensional.

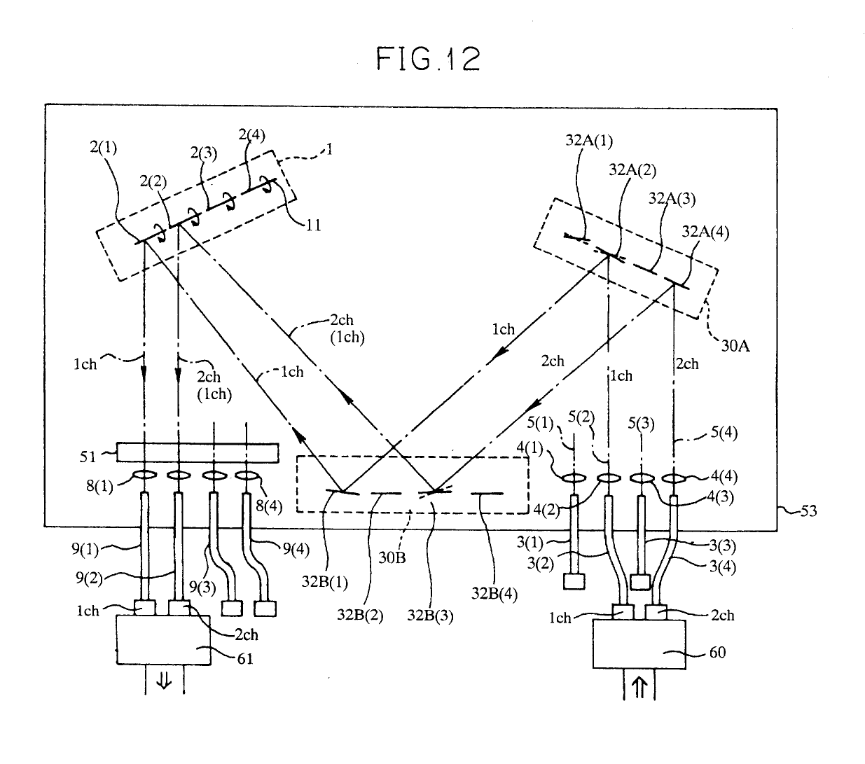

FIG. 12 describes the operation of the optical switch device for optical communication according to the second embodiment of the present invention.

The second embodiment is substantially equal to the first embodiment, and only different points are described, the same configuration is denoted by the same symbols, and description thereof is omitted.

In the first embodiment, the galvo unit 30A has three non-defective galvano mirrors, and two galvano mirrors 32A(2) and 32A(3) are used. If the galvano mirror 32A(3) is failed after assembling the optical switch 53 including these galvano mirrors in an upper rank system, this optical switch cannot be used any more in a condition with the optical fiber connected thereto as shown in FIG. 2.

Thus, in the second embodiment, a connector of the optical fiber 3(4) is connected to 2 ch of the input box 60 as shown in FIG. 12 to use the non-defective galvano mirror 32A(4) which has not been used yet. The optical switch 53 is now usable thereby.

As described above, a spare non-defective optical path selection element is provided in advance when the optical switch is assembled in the upper system, and if the optical path selection element is failed, the failed one is replaced by the spare optical path selection element for use. In this case, the system is usable only by extracting/inserting the optical fiber 3(i), and changing the optical path selection element to be drive-controlled on the software, and the system-down time and the cost can be considerably reduced. Thus, the service life of the optical switch device after the operation can be prolonged.

The number of spare galvano mirrors disposed in each galva unit must be set taking into consideration the yield during the manufacture if the spare galvano mirrors are provided for the defects during the manufacture. On the other hand, the number of spares must be set taking into consideration the durability of the optical switch during the operation if the spare galvano mirrors are provided for the defects during the operation.

In the above embodiments, the galvano mirrors to be tilted as the optical path selection element is used. In addition, another optical path selection element using the mirrors which are arranged in a matrix and selectively inserted in the optical path as shown, for example, in FIG. 6 of Japanese Unexamined Patent Application Publication No. 2000-258705 or U.S. Pat. No. 5,960,132 is adaptable by providing spares in a row unit. The galvano mirrors are also applicable to other optical path selection elements such as the optical path selection element using a waveguide.

A means for switching the optical path is not limited to the galvano mirror to tilt the mirrors, but other means may be acceptable. For example, the optical path selection element for driving a lens, a prism, or a phonogram element may be acceptable.

As described above, the present invention has advantages in that the yield of the optical switch in which a plurality of optical path selection elements are simultaneously manufactured can be improved, the service life of the optical switch device after the operation can be prolonged, or the repair cost in a failure can be reduced.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An optical switch device having a plurality of optical path selection elements for selectively switching a plurality of second optical paths to one or a plurality of first optical paths comprising:
at least one spare optical path selection element for the number required for exchanging the plurality of optical path selection elements in an optical switch device.

2. An optical switch device according to claim 1, wherein said plurality of optical path selection elements are connected to each other as an optical element drive unit, and manufactured.

3. An optical switch device according to claim 2, wherein said optical element drive unit is a galvo unit having a mirror.

4. An optical switch device according to claim 2, wherein said spare optical path selection element is used for a spare for any defect when manufacturing said optical element drive unit.

5. An optical switch device according to claim 1, wherein said spare optical path selection element is used for a spare for any defect when operating said optical path selection element.

6. An optical switch device according to any one of claims 1 to 3, wherein said optical path selection element has a sensor comprising a light emitting element and a plurality of split light receiving elements.

7. An optical switch device according to claim 6, wherein said sensor detects the inclination of the mirror.

8. An optical switch device according to claim 6, wherein said light receiving element is a PSD (Position Sensitive Detector).

9. A switch device according to claim 2 or claim 3 comprising input-output optical fibers and at least two optical element drive units.

10. An optical switch device according to claim 9, wherein a beam splitting means and a light receiving element are arranged between said optical element drive unit and output optical fiber.

11. An optical switch device according to claim 10, wherein said beam splitting means is a beam splitter.

12. An optical switch device according to claim 9, further comprising an input-output box.

13. An optical switch device according to claim 12, wherein said input-output box has a means for coupling a plurality of optical fibers.
